(19) United States
(12) Patent Application Publication
(10) Pub. No.: US 2008/0123903 A1
(43) Pub. Date: May 29, 2008

(54) SURVEYING APPARATUS

(75) Inventors: Shunji MATSUO, Tokyo (JP); Homu TAKAYAMA, Saitama (JP); Takanori YACHI, Tokyo (JP); Masatoshi SAKURAI, Saitama (JP)

Correspondence Address: GREENBLUM & BERNSTEIN, P.L.C., 1950 ROLAND CLARKE PLACE, RESTON, VA, 20191, US

(73) Assignee: PENTAX INDUSTRIAL INSTRUMENTS CO., LTD., Tokyo (JP)

(21) Appl. No.: 11/772,331

(22) Filed: Jul. 2, 2007

(30) Foreign Application Priority Data
Jul. 3, 2006 (JP) P2006-183924
Jul. 3, 2006 (JP) P2006-183926
Jul. 3, 2006 (JP) P2006-183929

(51) Int. Cl. G01C 11/00; G01C 15/02

(52) U.S. Cl. 382/106; 33/293

(57) ABSTRACT

A surveying apparatus is provided having a telescope, a digital camera, a measuring device, and a calculating device. The telescope collimates an aiming point on a surveying object. The digital camera has an imaging optical system provided separately from the telescopic optical system of the telescope. The measuring device measures the distance between the telescope and a surveying point to be surveyed. The calculating device calculates the location of the aiming point in an image which is captured by the digital camera.

### BACKGROUND OF THE INVENTION

1. Field of the Invention

The present invention relates to a surveying apparatus having an image-capturing apparatus.

2. Description of the Related Art

A surveying apparatus, e.g. a total station, surveys a surveying object by collimating an aiming point on the surveying object using a collimator which is provided in a telescope. The purpose of the survey is to measure the distance between a surveying origin and the object to be surveyed (surveying object). A total station emits a laser beam towards a surveying object, and observes the laser beam reflected back from the surveying object.

Some total stations have a digital camera. Light entering the telescope is divided by a prism, and the divided light is guided to a digital camera. The digital camera has lenses having a wider view angle than the telescope, and photographs an image in which the aiming point of the optical axis of a telescopic lens is centered, and displays the photographed image on a display provided in the total station. A user can approximately direct the total station towards the object by looking at the image on the display, and precisely direct it at the object by using the scope. The aiming point is aligned with the object for collimating. After the survey, the digital camera stores a recorded image into a memory medium provided in the total station.

When a user surveys an object in a reflector-less mode, the total station receives a laser beam reflected without a reflecting prism, which was emitted towards the surveying object by the total station. When using the reflector-less mode, it is not required to provide a reflecting prism on the surveying object. The reflector-less mode is utilized for surveying planimetric features or the corner of a construction on which a reflecting prism cannot be provided. After a user surveys these objects, it may be difficult to identify the aiming point on a display or a recorded image. A total station representing a surveyed point of a recorded image shown on a display is disclosed in Japanese Unexamined Patent Publication (KOKAI) No. 2004-340736.

### SUMMARY OF THE INVENTION

An object of the present invention is to provide a surveying apparatus, using which a user is able to recognize approximately the aiming point on a photographed image, which displays a point mark to indicate the aiming point on a captured image, and by which a user is able to choose whether the point mark indicating an approximate aiming point is superimposed onto an image or not, and recognizes the aiming point after image capture without difficulty.

A surveying apparatus is provided having a telescope, a digital camera, a measuring device, and a calculating device. The telescope collimates an aiming point on a surveying object. The digital camera has an imaging optical system provided separately from the telescopic optical system of the telescope. The measuring device measures the distance between the telescope and the surveying point to be surveyed. The calculating device calculates the location of the aiming point on an image which is captured by the digital camera.

### BRIEF DESCRIPTION OF THE DRAWINGS

The objects and advantages of the present invention will be better understood from the following description, with reference to the accompanying drawings in which:

FIG. 1 is a block diagram showing the total station as an embodiment of the present invention;

FIG. 2 is a front view of the total station;

FIG. 3 is a pattern diagram showing the physical relationship between an imaging optical system, a telescopic optical system, a surveying object, and an aiming point;

FIG. 4 is a flowchart showing the first superimposing process;

FIG. 5 is an image represented on the camera display;

FIG. 6 is a flowchart showing the second superimposing process;

FIG. 7 is a pattern diagram showing the physical relationship between an imaging optical system, a telescopic optical system, a surveying object, and an aiming point;

FIG. 8 shows a shot mark superimposed onto a stored image and displayed on the camera display;

FIG. 9 shows an image as displayed on the camera display;

FIG. 10A shows an image as displayed on the camera display before a point mark corresponds to an aiming point;

FIG. 10B shows an image as displayed on the camera display when a point mark corresponds to an aiming point;

FIG. 11 is a flowchart showing the third superimposing process;

FIG. 12 shows the data structure of a memory medium storing a surveying data file and an image file; and

FIG. 13 shows the data structure of a memory medium storing a surveying data file, and an image file having image layers.

### DESCRIPTION OF THE PREFERRED EMBODIMENTS

The present invention is described below with reference to the embodiments shown in the drawings.

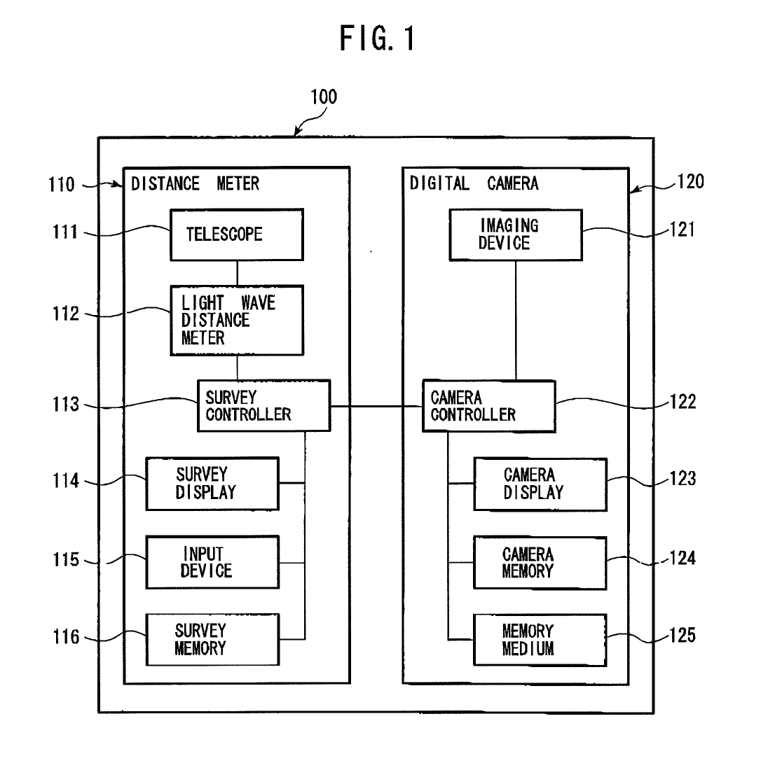

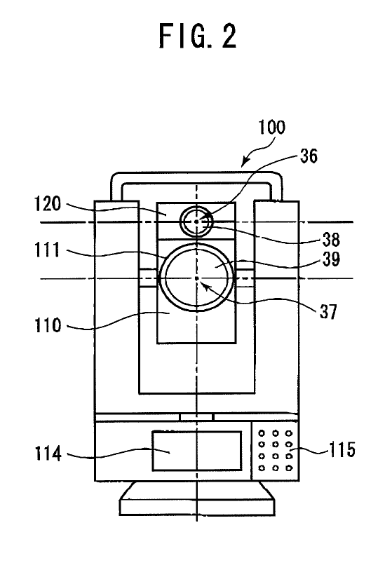

The constitution of a total station is described with reference to FIGS. 1, 2, and 3.

A total station comprises a distance meter 110 and digital camera 120. The distance meter 110 includes a telescope 111, having a telescopic optical system 39. A user collimates the aiming point 34 on a surveying object 33 using the telescopic optical system 39. The surveying object 33 can be a planimetric feature or a corner cube. The aiming point 34 is a point provided on the optical axis of the telescope for collimating. The digital camera captures an image using an imaging device 121.

A user directs a laser beam towards a collimated surveying object 33 using an input device 115. The laser beam is reflected by the surveying object 33, and enters the telescope 111. A laser beam entering the telescope 111 is guided to a light wave distance meter, and the phase of the laser beam is measured. The measured phase is stored temporarily in a survey memory 116, and then transferred to a survey controller 113. The survey controller 113 calculates the distance between the total station 100 and the surveying object 34. The survey controller 113 displays measuring data, information for controlling the total station 100, and any other relevant information, on a display 114. The total station 100 is operated using the input device 115, e.g. a keyboard. Surveying results data is stored in a memory medium 125 as measuring data, and the memory medium 125 is provided detachably in the digital camera 120.

The imaging device provided in the digital camera 120 comprises lenses, being a part or an imaging optical system, and a CCD image sensor (not shown in the figure) which converts light inputted through the lens into an electrical signal. An optical axis 36 of the imaging optical system 38 passes through the center of the effective pixel area of the CCD image sensor provided in the imaging device. The center of the photographed image corresponds to a point on the optical axis 36.

The imaging optical system 38 is independent from the telescopic optical system 39. Therefore, the light entering the telescope does not need to be divided, and the amount of light is sufficient for surveillance. Consequently, the surveying object 33 is properly visible to the telescopic optical system 39, and the imaging optical system 38 has a wider angle of view than that of the telescopic optical system 39.

A photographed image is stored temporarily in the camera memory 124, and processed by a camera controller 122 provided in the digital camera 120. Processed image data is displayed on a camera display 123, provided in the digital camera 120, as an image, and stored in the memory medium 125 as a recorded image. The memory medium 125 is provided detachably in the digital camera 120. Any photographing process executed in the digital camera 120, e.g. an imaging process, or a storing process, is executed by a user operating the input device 115 provided in the distance meter 110.

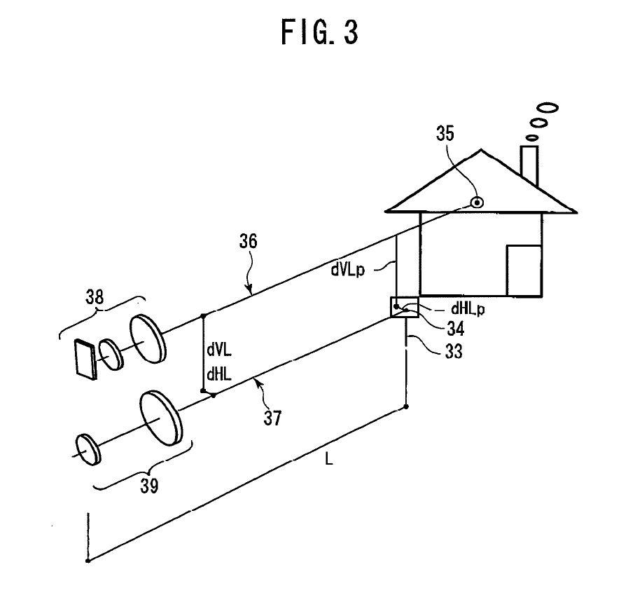

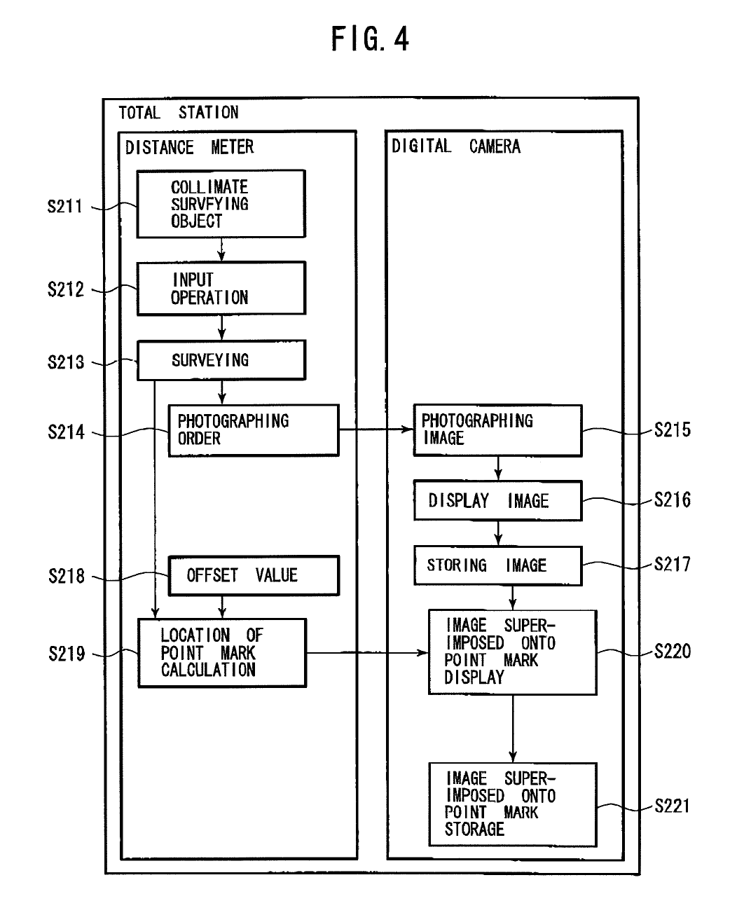

The first superimposing process that superimposes a point mark onto a stored image is described below with reference to FIGS. 3 and 4.

The aiming point on the optical axis 37 of the telescopic optical system 39 is aimed at the surveying object 33 by moving the telescopic optical system 39 of telescope 111 in step S211. A user collimates the aiming point 34 at the surveying object 33 herewith. In step S213, the distance L between the total station 100 and the surveying object 33 is measured, and then the surveying controller 113 orders the camera controller 122 provided in the digital camera 120 to capture an image in step S214.

The camera controller 122 captures an image in step S215. The captured image data is displayed on the camera display in step S123, and stored in a memory medium as a stored image in step S217. The memory medium, e.g. SD cards, etc., is provided detachably in the digital camera.

Offset quantities dHL and dVL, i.e. quantities of parallax, exist between the optical axis 37 of the telescopic optical system 39 and the optical axis 36 of the imaging optical system 38 because they are provided independently. The value dHL is the horizontal offset quantity, and the value dVL is the vertical offset quantity. In step S210, offset values are retrieved from the survey memory 116. The telescope 111 and the digital camera 120 are fixed on the total station 100 so that offset values are able to be measured in advance, and stored in the survey memory 116.

In step S219, the location of the point mark 42 on the stored image is calculated using the distance L between the total station 100 and the surveying object 33 by a mark calculating process described below. The point mark 42 is a way of indicating the position of the aiming point 34 on the stored image, and is represented by a cross.

In step S220, the stored image is retrieved from the memory medium 125, and the point mark is superimposed onto the stored image according to its calculated location. An image processing device (not shown), provided in the camera controller, creates an image of the point mark and superimposes the point mark onto the stored image using a known process.

In step S221, the stored image onto which the point mark superimposed is stored again in the memory medium 125. This process is completed herewith.

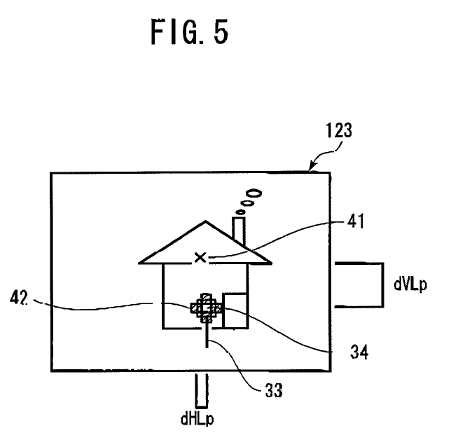

The mark calculating process that calculates the location of the point mark on the stored image is described using FIGS. 4 and 5. FIG. 4 is a pattern diagram showing the physical relationship between the optical axis 36 of the imaging optical system 39 in the imaging device 121, the optical axis 37 of the telescopic optical system 39 in the telescope 111, the surveying object 33, and the aiming point 34.

The aiming point 34 is collimated at a surveying object 33. The aiming point 34 is located on the optical axis 37 of the telescopic optical system 39. The difference between the point mark and the aiming point on the image is caused by the offset, and the amount of difference is the difference quantity. The difference quantity calculating process is described below.

The horizontal difference value is dHLp, and the vertical difference value is dVLp. The unit of the off set quantities is a number of pixels, and the method of calculating each offset quantity is described below:

dHLp=(ArcTan(dHL/L))/RXnθ

dVLp=(ArcTan(dVL/L))/RYnθ

RXnθ and RYnθ are horizontal and vertical resolutions per pixel of the CCD. The resolution is calculated by dividing the angle of view of the pixels in the CCD, which is decided according to the focal length of the lens, by the horizontal or vertical number of pixels.

The position of the surveying point 34 on an image is a position removed from the center of an image 41 by an amount corresponding to the horizontal difference value dHLp and the vertical difference value dVLp.

In the camera display in FIG. 5, the point mark 42 is displayed at a location removed by an amount dHLp in the horizontal plane and dVLp in the vertical plane from the center of the image. Therefore, a user can approximately recognize the location of the surveyed point on the captured image after survey.

According to the present embodiment, a total station comprises a telescope with a bright f-number, because an optical axis of the telescope is provided separately from an optical axis of a digital camera. A user can easily recognize the precise position of the surveyed point in the stored image, because an aiming point is provided on the center of a captured image.

Note that, the point mark 42 may be superimposed onto the image before the image data is stored in the memory medium. The point mark 42 is represented at a precise position in the camera display 123.

Another aspect of the present invention is described below with reference to the embodiments shown in the drawings. The description of the same constructions as the first aspect of the invention is omitted.

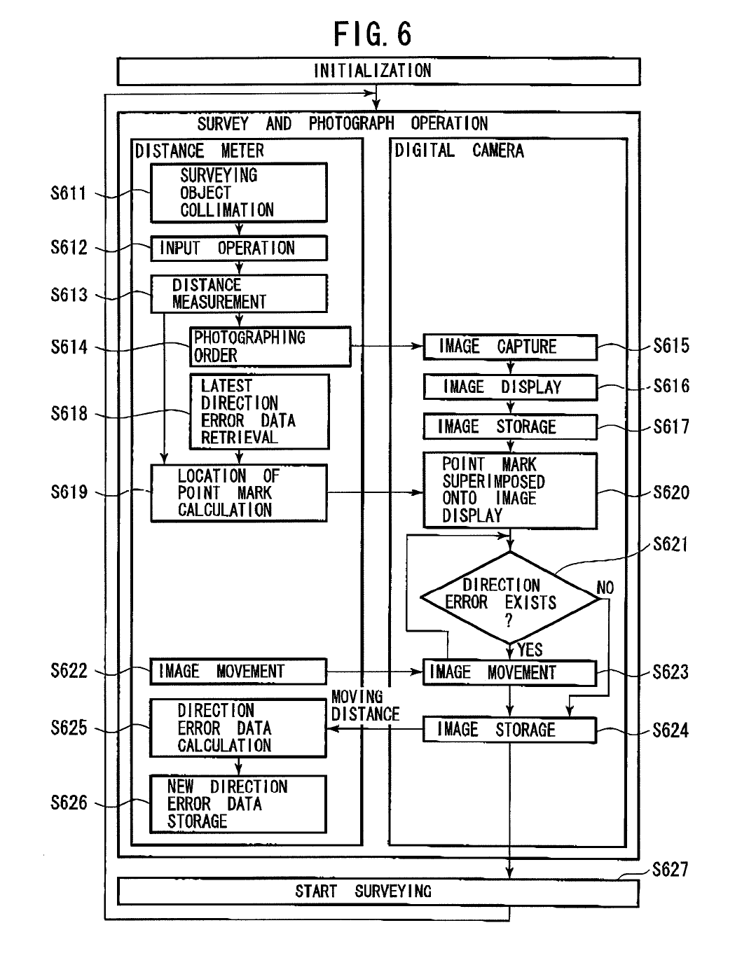

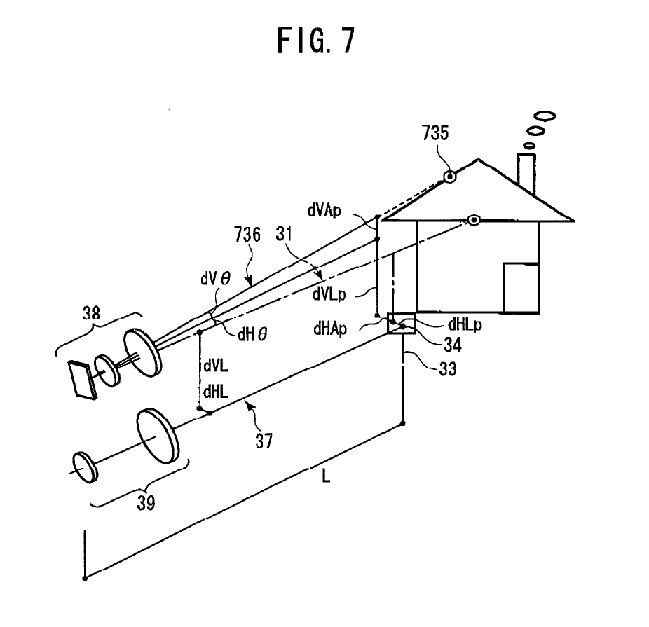

The second superimposing process that superimposes a point mark with a stored image is described below with reference to FIGS. 6 and 7. When the power of the total station is turned on, the second superimposing process begins. Steps S611 to S617 are the same as described in the first superimposing process, so their description is omitted.

In step S618, the direction error is retrieved from the survey memory 116. Direction error data is a vector quantity which was calculated in a last surveying by a process as described below and stored in the survey memory.

In step S619, the position of a shot mark on a recorded image is calculated by the process described below. A shot mark is a symbol to approximately indicate the aiming point 34.

In step S620, a stored image is retrieved from the memory medium 125, and the point mark is superimposed in the stored image according to its calculated position. An image processing device (not shown) provided in the camera controller creates a symbol image of the point mark and superimposes the point mark onto the stored image using a known process.

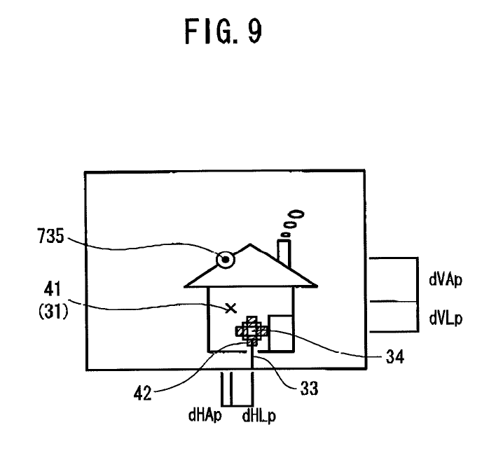

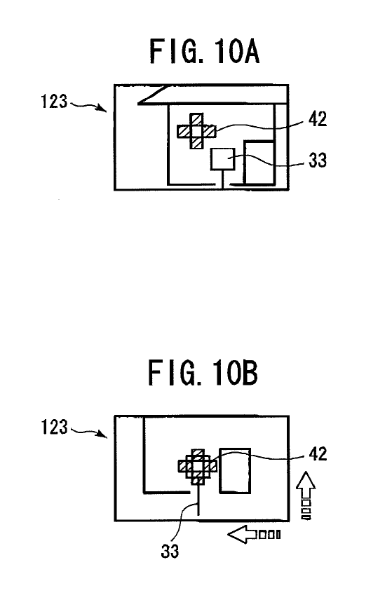

The precise position of the point mark on the image is calculated in step S621-S623. In step S621, a user judges whether the position of the point mark precisely corresponds with the surveying object 33, i.e. whether a direction error is generated, by observing the image and the point mark on the camera display 123, A direction error (dHAp, dVAp) is a vector quantity that represents an error between the optical axis 37 of the telescopic optical system 39 and the optical axis 36 of the imaging optical system 38. When the axes do not precisely correspond to each other, i.e. a direction error is generated, a user moves the image on the camera display 123 using the input device 115, and makes the position of the point mark on the image correspond with the position of the surveying object 33 in step S622 and S623. For example with reference to FIG. 9, the aiming point 34 corresponds to the surveying object 33. Further, when the surveying apparatus has the direction error, the aiming point 34 of the image displayed in the camera display 123 does not correspond to the surveying object 33 (refer to FIG. 10(a)). A user moves the image displayed in the camera display 123 to make the aiming point 34 correspond to the surveying object 33 (refer to FIG. 10(b)). When the two points correspond, or the position of the point mark already precisely corresponds with the position of the surveying object 33, the point mark is superimposed onto the stored image and the resulting image is stored in the memory medium 125 in step S624.

Direction error data is calculated in step S625 by the process described below, using the movement distance of the image from step S622 and S623. The direction error data is stored in the survey memory 116 in step S626. The preparation for surveying is completed herewith, and the survey is executed in step S627.

The error data calculating process is described using FIGS. 7-10. FIG. 7 is a pattern diagram showing the optical axis 736 of the imaging optical system 38 in the digital camera, the optical axis 37 of the telescopic optical system 38 in the collimator, the aiming point 34, and the surveying object 33. The aiming point 34 is collimated with the surveying object 33.

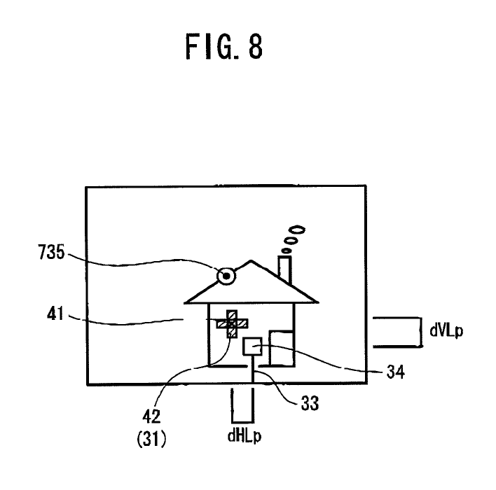

In the present embodiment, offset quantities dHL and dVL, i.e. quantities of parallax, exist between the optical axis 37 of the telescopic optical system 39 and the optical axis 736 of the imaging optical system 38. The error data calculating process begins with calculating the difference quantity. The difference quantity calculating process in the present embodiment is described below with reference to FIGS. 7 and 8.

After the distance L between the total station 100 and the surveying object 33 has been measured, the imaging device 121 captures an image of a surveying object and its surroundings. The captured image is displayed in the camera display 123. The center point 735 of the image displayed in the camera display 123 does not correspond to the aiming point 34 located on the optical axis 37 of the telescopic optical system 39, because the optical axis 736 of the imaging optical system 38 does not correspond to the optical axis 37 of the telescopic optical system 39.

The difference quantities dHLp and dVLp are calculated using the formulae described above. The value dHLp is the difference between a difference corrected point 41 and the center point 735 in the horizontal direction. The value dVLp is the difference between a difference corrected point 41 and the center point 735 in the vertical direction. The difference corrected point 41 does not include the offset value, but includes the direction error.

The point mark 42 is displayed coincident with the difference corrected point 41 which is removed from the center of the image 735 by an amount corresponding to the offset quantities dHLp and dVLp. The offset quantities dHLp and dVLp are stored in the survey memory as an initial value E0 of the direction error data.

The process of calculating direction error data is described below.

A typical user surveys outside during daytime, so a digital camera and a member constituting a telescope may expand and contract due to a change of temperature and radiated heat from the sun. Direction errors caused by the angle produced by crossing the optical axis of the telescopic optical system and the optical axis of the imaging optical system can be produced. These direction errors prevent a user from recognizing the aiming point on an image. The process of calculating direction error data solves the problem.

The total station 100 shown in FIG. 7 has a direction error between the optical axis 736 and the standard axis 31. The standard axis is parallel to the optical axis 37, and the direction error is exaggerated in the figure. The value dHAp is the horizontal direction error, and the value dVAp is the vertical direction error. Each direction error is described as a number of pixels.

With reference to FIG. 8, the point mark 42 is displayed coincident with the difference corrected point 41 in the camera display 123. A user operates the input device 115 with reference to the image and the point mark 42 in the camera display 123.

With reference to FIG. 9, the point mark 42 is made to correspond with the surveying object 33 in the camera display 123 by the image being moved according to the operation of a user. The movement vector of the image in the horizontal direction is dHAp, and the movement vector in the vertical direction is dVAp. The movement vectors represent the direction error.

Therefore, the actual position of the surveying point 34 is a position removed by an amount corresponding to dHLp and dHAp in the horizontal plane, and dVLp and dVAp in the vertical plane, respectively, from the center of the image (refer to FIG. 9).

This direction error is added to the direction error data E0 which is stored in the survey memory 116, and stored in the survey memory as the latest direction data E1. When the direction error is calculated for a surveying object which has the same distance L, direction error data E1 is retrieved, and added to the direction error calculated at that time. The new direction error data, to which direction error data E1 is added, is stored in the survey memory as the latest direction error data E2 and saved in the memory medium 125 with information which associates the direction error data E2 with the relevant captured image. Direction error data En is added every time the direction error is calculated.

The standard axis 31 and the optical axis 736 create a direction error angle. The direction error angle is calculated with dHAp and dVAp. The direction error angle in the horizontal plane is dHAp, and in the vertical plane is dVAp. dHAp and dVAp are calculated by formulae described below:

dHθ=dHAp·RXnθ

dVθ=dVAp·RYnθ

The position of the point mark 42 is calculated using the direction error angle which is calculated by dividing the direction error by the resolution in step S219 and S220.

According to the present embodiment, the total station includes a telescope having a bright f-number. A user can recognize the precise position of the aiming point in a stored image in case a direction error is created between the optical axis 37 of the telescopic optical system 39 and the optical axis 736 of the imaging optical system 38.

Note that the second superimposing process may be executed every time that a surveying object is surveyed. An image superimposed with the aiming point placed at a precise position is provided for every surveying point.

Also, note that the position of the point mark 42 may correspond with the surveying object 33 by moving the point mark 42 on the camera display 123. The distance moved by the point mark 42 represents the direction error.

Further, note that the point mark 42 may be superimposed onto the image before the image data is stored in the memory medium 125. In this case, the point mark 42 is represented at a position on the camera display not including the direction error.

In the present embodiment, the direction error data may not be integrated, but it may be direction error acquired at every surveying point.

The direction error may be substituted by the direction error angle. The direction error angle may be stored in the surveying memory 116 or the memory medium 125.

Another aspect of the present invention is described below with reference to the embodiments shown in the drawings. Description of constructions common with previously-mentioned aspects of the invention is omitted.

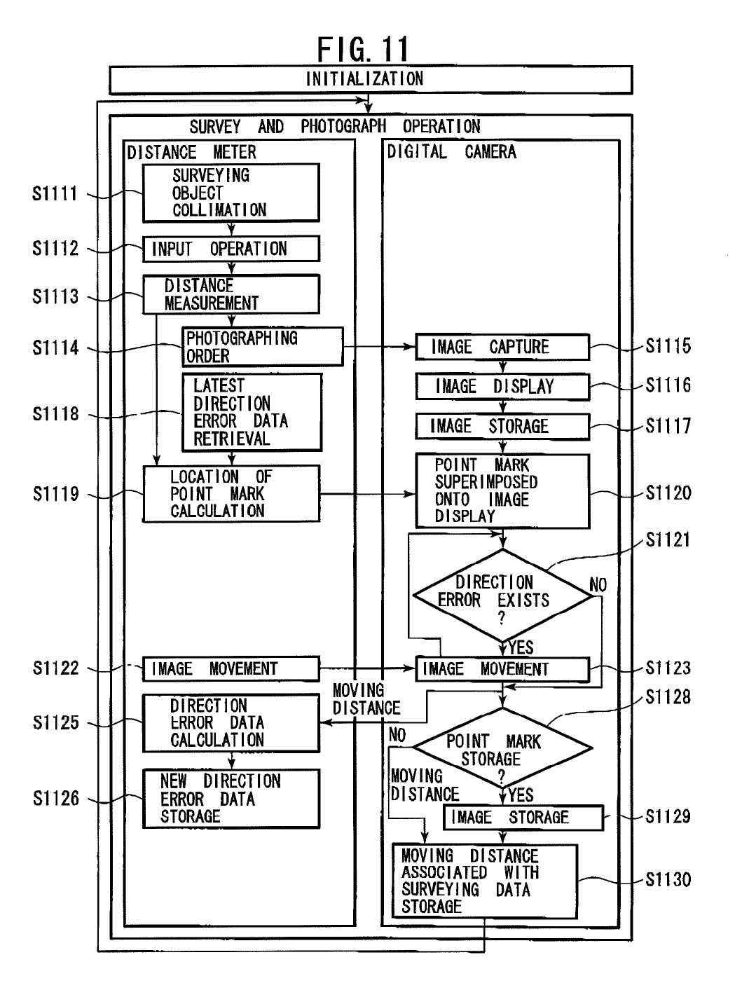

The third superimposing process which superimposes a point mark onto a stored image is described below with reference to FIGS. 7 and 11.

When the power of the total station 100 is turned on, the third superimposing process begins. Steps S1111 to S1118 are the same as those in the second superimposing process, so their descriptions are omitted.

In step S1119, the position of the point mark is calculated by the process described below using the difference quantity and the direction error data.

In step S1120, the stored image is retrieved from the memory medium 125, and the point mark is superimposed onto the stored image according to the calculated position of the point mark.

The process of acquiring the precise position of the point mark in the image and storing it in the survey memory 116 is executed from step S1121 to step S1123 by the processes described above.

The direction error data is calculated by the process described below in step S1125. In this process, the movement distance by which a user must move the image in step S1122 and S1123 is used. The direction error data is stored in surveying memory 116 in step S1126.

A user selects whether the point mark is to be superimposed onto the image using the input device 115. If the option to superimpose is selected, the point mark is superimposed onto the image, and the image is stored in the memory medium 125. In either case, the image which does not have the point mark superimposed onto it, and the information of the position of the aiming point 34 in the image, i.e. the position of the point mark in the image, are stored in the memory medium 125 in step S1130. Subsequently, a user can retrieve an image which has not had the point mark superimposed onto it, if the point mark on the image is not required after surveying.

The position information of the point mark is represented by the difference between the center of the image and the location of the aiming point. The difference is represented by orthogonal coordinates qualified by a horizontal axis and a vertical axis whose origin is the center point of the image.

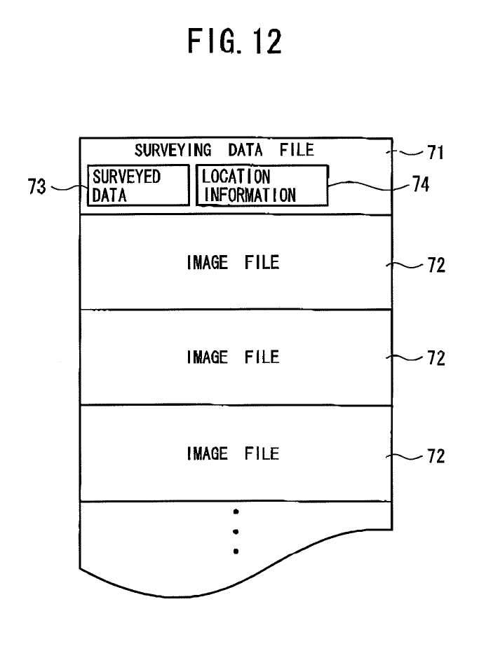

The storing process of storing the image and the position information is described with reference to FIG. 12.

The position information is a not stored in the image file 72, but is stored in a surveyed data file 71 with information regarding the image file 72, i.e. the file name of the image file 72. The surveyed data 73 is saved in a text format in the surveyed data file 71. The surveyed data file 71 and the image file 72 are provided separately. One line in the surveying data file is assigned to one-time surveying. The surveying data 73 and the information concerned with the surveying data 73 are written in that liner separated by a comma. The surveyed data file 71 is stored in the memory medium 125.

After surveying, the total station displays the point mark on the image with reference to the stored image and the position information stored in the memory medium 125, even if the point mark is not superimposed onto the stored image.

According to this embodiment, a user can confirm the precise position of the point mark 42 after surveying because the point mark 42 does not overlap with the image.

Note that, a computer may display the point mark together with the image on its display with reference to the stored image and the position information stored in the memory medium 125.

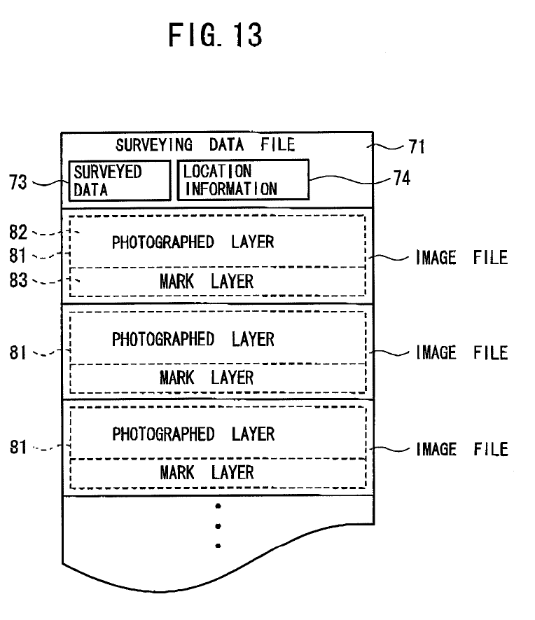

Also note that, with reference to FIG. 13, the image file 81 may comprise a mark layer 83 on which the point mark is displayed, and a photographed layer 82 on which the surveying object and its surroundings are displayed. The camera controller superimposes the point mark with the mark layer 83 with reference to the position information. According to this construction, the surveying object and its surroundings, and the point mark, may be displayed individually on the camera display 123 by managing only one file.

Note that, the position information may not be stored in the surveyed data file 71, and may be stored in another file.

Moreover, the memory medium 125 may be a flash memory or other storage device provided in the digital camera 120.

Although the embodiment of the present invention has been described herein with reference to the accompanying drawings, obviously many modifications and changes may be made by those skilled in the art without departing from the scope of the invention.

The present disclosure relates to subject matter contained in Japanese Patent Application Nos. 2006-183924 (filed on Jul. 3, 2006), 2006-183926 (filed on Jul. 3, 2006), and 2006-183929 (filed on Jul. 3, 2006), which are expressly incorporated herein, by reference, in their entirety.

1. A surveying apparatus comprising:
a telescope that collimates an aiming point on a surveying object;
a digital camera that has an imaging optical system provided separately from the telescopic optical system of said telescope;
a measuring device that measures the distance between said telescope and a surveying point to be surveyed; and
a calculating device that is for calculating the location of the aiming point in an image which is captured by said digital camera.

2. The surveying apparatus according to claim 1, wherein the calculating device calculates the location of the aiming point in the image by using the difference between the optical axis of the imaging optical system and the optical axis of the telescopic optical system, and the distance between said surveying apparatus and the surveying object as measured by said measuring device.

3. The surveying apparatus according to claim 1 further comprises:
a point mark that indicates the location of the aiming point; and
a superimposing device that superimposes said point mark onto the image.

4. The surveying apparatus according to claim 1 further comprising:
a display device that shows an image taken by said digital camera;
a point mark that indicates the location of the aiming point; and
a superimposing device that superimposes said point mark onto the imager and represents the image on said display device.

5. The surveying apparatus according to claim 1 further comprising:
a point mark that indicates the location of the aiming point; and
a memory device that stores image data which is created by superimposing said point mark onto the image.

6. The surveying apparatus according to claim 4 further comprising an adjusting device that is used to relatively move the image and the point mark.

7. The surveying apparatus according to claim 6 wherein the adjusting device has an operating device moving the image to the point mark.

8. The surveying apparatus according to claim 6 wherein the adjusting device has an operating device moving the point mark to the image.

9. The surveying apparatus according to claim 6, further comprising a memory device that stores error data, which data is the movement distance of the point mark or image.

10. The surveying apparatus according to claim 6, further comprising a memory device that stores error data, which data is the distance between the point mark and the center of the image.

11. The surveying apparatus according to claim 6, further comprising a memory device that stores error data, which data is the angle between the optical axis of the telescopic optical system and the optical axis of the imaging optical system.

12. The surveying apparatus according to claim 9, further comprising a superimposing device that superimposes said point mark onto the image using the error data.

13. The surveying apparatus according to claim 10, further comprising a superimposing device that superimposes said point mark onto the image using the error data.

14. The surveying apparatus according to claim 11, further comprising a superimposing device that superimposes said point mark onto the image using the error data.

15. The surveying apparatus according to claim 6, wherein the superimposing device superimposes said point mark onto the image using the error data when the power of the surveying apparatus is on.

16. The surveying apparatus according to claim 6, wherein the adjusting device moves the image and the point mark relative to each other, when the power of the surveying apparatus is on.

17. The surveying apparatus according to claim 6, wherein the superimposing device superimposes said point mark onto the image using the error data before the surveying object is surveyed.

18. The surveying apparatus according to claim 6, wherein the adjusting device moves the image and the point mark relative to each other, before the surveying object is surveyed.

19. A surveying apparatus comprising:
a telescope that collimates an aiming point on a surveying object;
a digital camera that captures an image of the surveying object;
a point mark that indicates the location of the aiming point;
a superimposing device that superimposes said point mark onto the image; and
a selecting device that decides whether the superimposing device superimposes said point mark onto the image.

20. The surveying apparatus according to claim 19, further comprising a memory device that stores the image and a superimposed image which includes the image and the point mark.

21. The surveying apparatus according to claim 19, further comprising a memory device that stores the image and location information which indicates the location of the aiming point in the image.

22. The surveying apparatus according to claim 21, wherein the location information is represented by a relative position between the center of the image and the aiming point.

23. The surveying apparatus according to claim 20, wherein the memory device stores the image and the location information in separate files.

24. The surveying apparatus according to claim 23, wherein the memory device stores a file having the location information of an image and information which associates the location information with the image.

25. The surveying apparatus according to claim 19, further comprising an image data producing device, producing image data which comprises a surveying object layer for recording the image and a mark layer for recording the point mark.

26. The surveying apparatus according to claim 25, further comprising a memory device storing the image data.
